(19) United States
(12) Patent Application Publication
(10) Pub. No.: US 2026/0196880 A1
(43) Pub. Date: Jul. 9, 2026

(54) WIRELESS CHARGING-ENABLED DATA STORAGE DEVICE

(71) Applicant: Sandisk Technologies, Inc., Milpitas, CA (US)

(72) Inventor: Sankalp Dubey, Bhopal (IN)

(21) Appl. No.: 19/013,657

(22) Filed: Jan. 8, 2025

(51) Int. Cl. H02J 50/40; H02J 50/00; H02J 50/12

(52) U.S. Cl. CPC H02J 50/40; H02J 50/005; H02J 50/12

(57) ABSTRACT

Examples described herein provide a wireless charging-enabled data storage device. For example, data storage devices described herein may be capable of forming both a wired and wireless connection with a mobile device. When connected only with a mobile device, the data storage device is powered by the mobile device. When an external power supply is also connected to the data storage device, the data storage device receives wireless power from the external power supply. The data storage device may then charge the mobile device using a portion of the wireless power received from the external power supply.

### BACKGROUND

This application relates generally to external data storage devices, and more specifically, to a wireless charging-enabled data storage device capable of being connected to an external power supply and a mobile device.

Mobile devices, such as mobile phones, may utilize external data storage devices for additional memory storage. Mobile devices are increasingly capable of capturing and processing high-quality media content (e.g., 4K content). Additionally, live recording setups may include a film cage, an external data storage device, a microphone, and additional devices, all of which may be powered directly by the battery of the mobile device.

### SUMMARY

External data storage devices for mobile devices, such as solid state drives (SSDs), are large and power-consuming, consuming power from the battery of the mobile device and further degrading the battery life of the battery. However, external storage devices are becoming necessary to capture and store high-quality content using a camera of mobile devices, such as 4K content. Examples described herein provide an external data storage device for a mobile device that is also capable of receiving power from an external power supply. The data storage device may pass-through a portion of the power from the external power supply to the mobile device. The data storage device may include two wireless power circuits to such that, in some examples, the data storage device receives power from an external power supply and supplies power to a mobile device simultaneously.

In one embodiment, a data storage device includes a controller. The controller is configured to wirelessly receive, with a first power transfer circuit, power from an external power supply, and wirelessly supply, with a second power transfer circuit, a portion of the power from the external power supply to a mobile device.

In another embodiment, a method performed by a data storage device includes receiving, with a power controller, power from a mobile device and detecting, with the power controller, a connection of an external power supply to the data storage device. The method includes initiating, with the power controller and in response to the detection of the connection of the external power supply to the data storage device, wireless power transfer from the external power supply to the data storage device and terminating, with the power controller and in response to the detection of the connection of the external power supply to the data storage device, power transfer from the mobile device to the data storage device.

In another embodiment, a data storage device includes a controller. The controller is configured to receive power from a mobile device, detect a connection of an external power supply to the data storage device, initiate, in response to the detection of the connection of the external power supply to the data storage device, wireless power transfer from the external power supply to the data storage device, and terminate, in response to the connection of the external power supply to the data storage device, power transfer from the mobile device to the data storage device.

Various aspects of the present disclosure provide for improvements in memory devices. The present disclosure can be embodied in various forms. The foregoing summary is intended solely to give a general idea of various aspects of the present disclosure and does not limit the scope of the present disclosure in any way.

### BRIEF DESCRIPTION OF THE DRAWINGS

FIG. 1 is a side view of a power system, according to some embodiments.

FIG. 2 is an exploded view of the power system of FIG. 1, according to some embodiments.

FIG. 3 is a perspective view of a data storage device, according to some embodiments.

FIG. 4 is a perspective view of another data storage device, according to some embodiments.

FIG. 5 is a block diagram of a mobile device, a data storage device, an external power supply, and an accessory, according to some embodiments.

FIG. 6 is a block diagram of the mobile device and the data storage device of FIG. 5, according to some embodiments.

FIG. 7 is a block diagram illustrating wired interfaces between the data storage device and the mobile device and the accessory, respectively, according to some embodiments.

FIG. 8 is a block diagram illustrating wireless power interfaces and wireless communication interfaces between the data storage device and the mobile device and the external power supply, respectively, according to some embodiments.

FIG. 9 is a block diagram of an intermediate internal power supply system of the data storage device of FIG. 5, according to some embodiments.

FIG. 10 is a block diagram illustrating a power controller of the data storage device of FIG. 5 communicating with and regulating power from an external power supply, according to some embodiments.

FIG. 11 is a block diagram illustrating the power controller of the data storage device of FIG. 5 communicating with and regulating power to a mobile device, according to some embodiments.

FIG. 12 is a block diagram illustrating an example of a mobile device connected to wired interface of the data storage device of FIG. 5, according to some embodiments.

FIG. 13 is a block diagram illustrating an example of the data storage device of FIG. 5 connected to a mobile device via a wireless power interface and an accessory via a wired interface, according to some embodiments.

FIG. 14 is a block diagram illustrating a first example method of changing from power reception to power delivery performed by the power controller of FIG. 5, according to some embodiments.

FIG. 15 is a diagram of an example film cage configured to support a mobile device connected to a data storage device, according to some embodiments.

FIG. 16 is a diagram of a side view of the example film cage of FIG. 15.

### DETAILED DESCRIPTION

In the following description, numerous details are set forth, such as data storage device configurations, and the like, in order to provide an understanding of one or more aspects of the present disclosure. It will be readily apparent to one skilled in the art that these specific details are merely exemplary and not intended to limit the scope of this application. The following description is intended solely to give a general idea of various aspects of the present disclosure and does not limit the scope of the disclosure in any way. Furthermore, it will be apparent to those of skill in the art that, although the present disclosure refers to NAND flash, the concepts discussed herein are applicable to other types of solid state memory, such as NOR, PCM (“Phase Change Memory”), ReRAM, etc.

External data storage devices for mobile devices, such as solid state drives (SSDs), are large and power-consuming, consuming power from the battery of the mobile device and further degrading the battery life of the battery. However, external storage devices are becoming necessary to capture and store high-quality content using a camera of mobile devices, such as 4K content. Additionally, while some live recording setups are available with a film cage, an external SSD, and other accessories (such as microphones), these setups are not portable and consume power from the battery of the mobile device.

Examples described herein provide an external data storage device that is capable of data transfer to a mobile device while receiving power from an external power supply. In some instances, the external data storage device is also capable of pass-through charging to the mobile device by providing a portion of power from the external power supply to the mobile device. The pass-through charging may be performed using one or more wireless charging circuitry. The external data storage device may be a dual-MagSafe™ system, connecting to both the mobile device and the external power supply magnetically using MagSafe architecture.

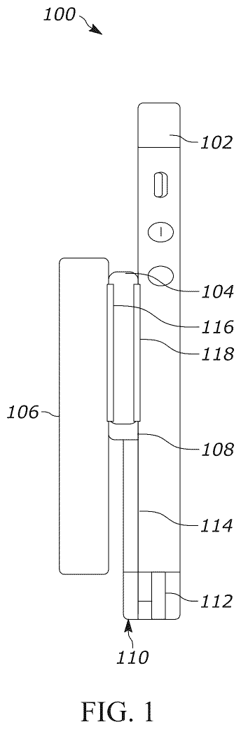

FIG. 1 is a side view of an example power system 100. The example power system 100 includes a mobile device 102, a data storage device 104 (e.g., an external data storage device), and an external power supply 106 (e.g., an external battery pack, an external power supply). The mobile device 102 may be a smartphone or other portable computing device. In the example power system 100, the data storage device 104 is positioned between the mobile device 102 and the external power supply 106. In other instances, the external power supply 106 may be omitted such that the data storage device 104 is only connected to the mobile device 102.

The data storage device 104 includes a connection assembly 114 for forming a physical (e.g., wired) connection between the mobile device 102 and the data storage device 104. In some instances, the connection assembly 114 is integrated with the data storage device 104. In other instances, the connection assembly 114 is connected to the data storage device 104 via a port 108. The connection assembly 114 may be a stretchable port connector that may be expanded or contracted based on a spring mechanism or an elastic material. In some examples, the connection assembly 114 includes a socket 110 (e.g., a female port) for receiving an accessory, such as a microphone or a speaker. The connection assembly 114 also includes a port 112 (e.g., a male port) for connecting to the mobile device 102. The port 108, the socket 110 and/or the port 112 may be, for example, USB ports, USB-C ports, or some other standard port for connecting two devices for power and/or data communication. The data storage device 104 may be capable of power and/or data transfer to the mobile device 102 via the connection assembly 114 (e.g., through the port 108 and the port 112).

The data storage device 104 also includes a first power transfer circuit 116 (e.g., a first wireless power transfer circuit) and a second power transfer circuit 118 (e.g., a second wireless power transfer circuit). The first power transfer circuit 116 and the second power transfer circuit 118 may be integrated within a housing of the data storage device 104. The first power transfer circuit 116 may be configured to be wirelessly connected to the external power supply 106 such that power is wirelessly transferred from the external power supply 106 to the data storage device 104. The second power transfer circuit 118 may be configured to be wirelessly connected to the mobile device 102 such that power is wirelessly transferred from the data storage device 104 to the mobile device 102.

In some implementations, the first power transfer circuit 116 and the second power transfer circuit 118 are MagSafe circuits that enable wireless power transfer between connected devices and magnetically couple connected devices. In this manner, the data storage device 104 may be magnetically secured to the mobile device 102 via the second power transfer circuit 118, and the data storage device 104 may be magnetically secured to the external power supply 106 via the first power transfer circuit 116. The mobile device 102 may magnetically connect to the data storage device 104 on a first side of the data storage device 104. The external power supply 106 may magnetically connect to the data storage device 104 on a second side of the data storage device 104.

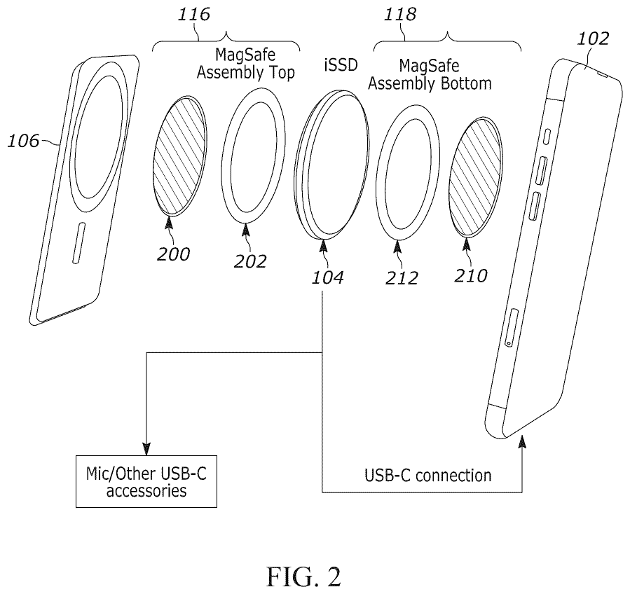

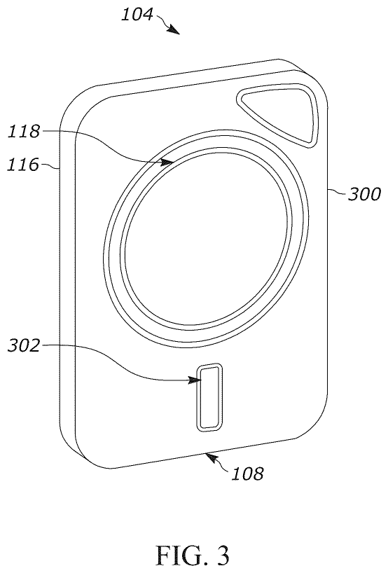

FIG. 2 is an exploded view of the power system 100 according to one example. As shown in FIG. 2, the first power transfer circuit 116 may include a first induction coil 200 and a first magnetic array 202. The second power transfer circuit 118 may include a second induction coil 210 and a second magnetic array 212. The first induction coil 200 provides wireless power transfer between the external power supply 106 and the data storage device 104. The first magnetic array 202 may assist with aligning the data storage device 104 when forming a connection between the external power supply 106 and the data storage device 104. Similarly, the second induction coil 210 provides wireless power transfer between the mobile device 102 and the data storage device 104. The second magnetic array 212 may assist with aligning the data storage device 104 when forming a connection between the mobile device 102 and the data storage device 104.

FIG. 3 is a perspective view of one example data storage device 104. The example data storage device 104 of FIG. 3 includes the first power transfer circuit 116 and the second power transfer circuit 118 integrated in a housing 300. The port 108 is located at a bottom portion of the housing 300. The data storage device 104 also includes an alignment magnet 302 to assist with aligning the data storage device 104 during connection of the data storage device 104 to the mobile device 102.

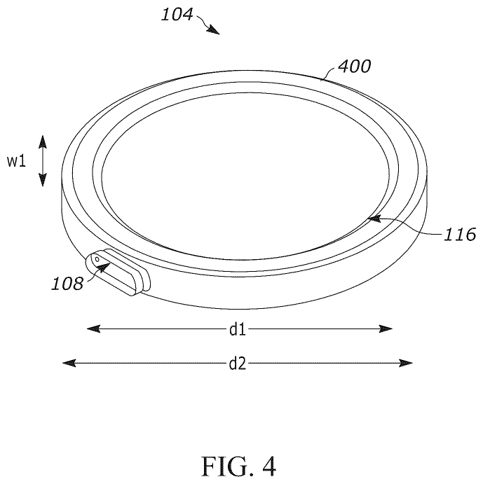

FIG. 4 is a perspective view of another example data storage device 104. The example data storage device 104 of FIG. 4 includes the first power transfer circuit 116 and the second power transfer circuit 118 (not shown) integrated into a housing 400. The port 108 is situated on an outer periphery of the housing 400. The data storage device 104 has an inner diameter d1, an outer diameter d2, and a width w1. The inner diameter d1 may be, for example, 55 millimeters (mm). The outer diameter d2 may be, for example, 60 mm. The width w1 may be, for example, 4 mm.

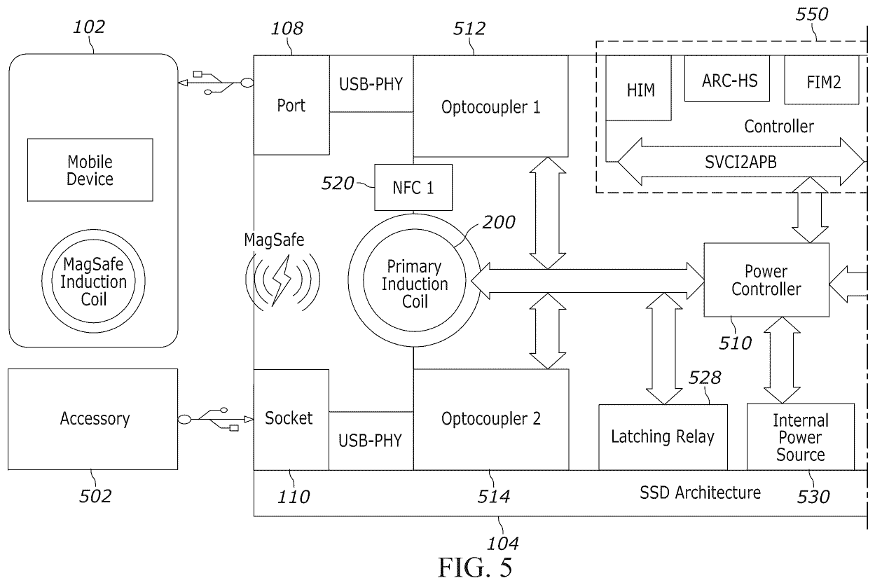

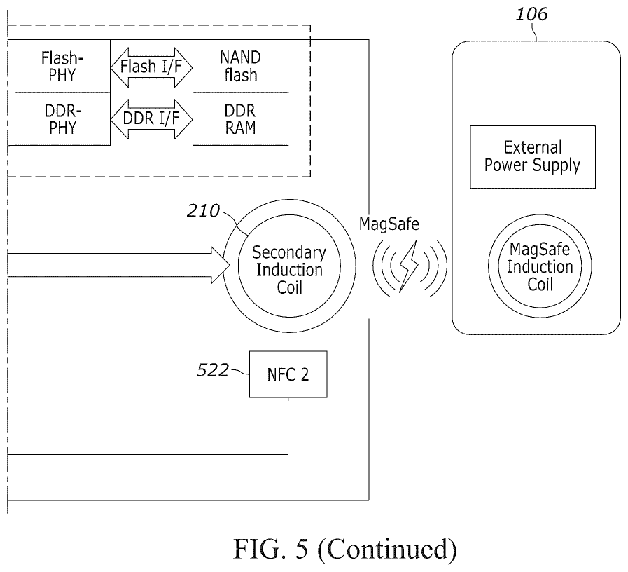

FIG. 5 is a block diagram of the mobile device 102, the data storage device 104, the external power supply 106, and an accessory 502 according to one example. The data storage device 104 includes, among other things, a power controller 510, a first optocoupler 512, a second optocoupler 514, the port 108, the socket 110, a first communication circuit 520, a second communication circuit 522, the first induction coil 200, the second induction coil 210, a latching relay 528, an internal power source 530, and a memory 550. The power controller 510 is configured to control the flow of power between the mobile device 102, the external power supply 106, the internal power source 530, the power controller 510, and the memory 550.

The data storage device 104 may be connected (e.g., wirelessly connected) to the external power supply 106 via the second induction coil 210. The data storage device 104 may be connected (e.g., wirelessly and/or physically connected) to the mobile device 102 via the first induction coil 200 and/or the port 108. An accessory 502 may also be connected to the data storage device 104 via the socket 110, such as a microphone, a speaker, a charger, or the like.

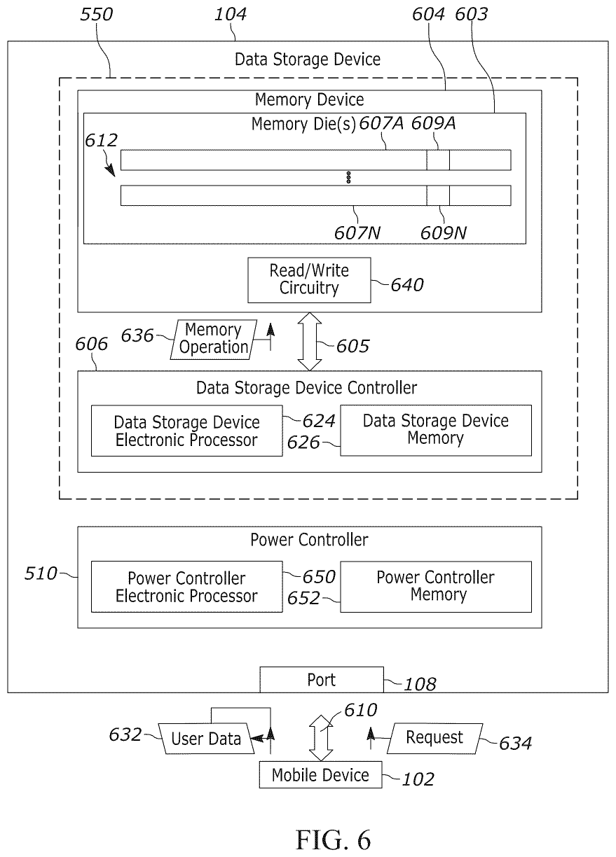

FIG. 6 is a block diagram of one example of the data storage device 104 in communication with the mobile device 102. In the example of FIG. 6, only the power controller 510 and components included within the memory 550 are shown for the sake of simplicity. The memory 550 includes a memory device 604 (e.g., non-volatile memory) that is coupled to a data storage device controller 606.

One example of the structural and functional features provided by the data storage device controller 606 are illustrated in FIG. 6. However, the data storage device controller 606 is not limited to the structural and functional features provided by the data storage device controller 606 in FIG. 6. The data storage device controller 606 may include fewer or additional structural and functional features that are not illustrated in FIG. 6.

The data storage device 104 and the mobile device 102 may be operationally coupled with a connection (e.g., a communication path 610), such as a bus or a wireless connection. The data storage device 104 may be removable from the mobile device 102 (i.e., “removably” coupled to the mobile device 102). As an example, the data storage device 104 may be removably coupled to the mobile device 102 in accordance with a removable universal serial bus (USB) configuration. In some implementations, the data storage device 104 may include or correspond to an SSD, which may be used as an embedded storage drive (e.g., a mobile embedded storage drive), an enterprise storage drive (ESD), a client storage device, a cloud storage drive, or other suitable storage drives.

The data storage device 104 may be configured to be coupled to the mobile device 102 with the communication path 610, such as a wired communication path and/or a wireless communication path (for example, a cord or the connection assembly 114 connected via the port 108). In some embodiments, the port 108 may include one or more electrical signal contact pads or fingers that provide electrical communication between the data storage device 104 and the mobile device 102.

The mobile device 102 may include a processor and a memory. The memory may be configured to store data and/or instructions that may be executable by the processor. The memory may be a single memory or may include one or more memories, such as one or more non-volatile memories, one or more volatile memories, or a combination thereof. The mobile device 102 may issue one or more commands to the data storage device 104, such as one or more requests to erase data at, read data from, or write data to the memory device 604 of the data storage device 104. For example, the mobile device 102 may be configured to provide data, such as user data 632, to be stored at the memory device 604 or to request data 634 to be read from the memory device 604. The mobile device 102 may include a mobile smartphone, a music player, a video player, a gaming console, an electronic book reader, a personal digital assistant (PDA), a computer, such as a laptop computer or notebook computer, any combination thereof, or another suitable electronic device.

The mobile device 102 communicates with a memory interface that enables reading from the memory device 604 and writing to the memory device 604. In some examples, the mobile device 102 may operate in compliance with an industry specification, such as a Universal Flash Storage (UFS) Host Controller Interface specification. In other examples, the mobile device 102 may operate in compliance with one or more other specifications, such as a Secure Digital (SD) Host Controller specification or other suitable industry specification. The mobile device 102 may also communicate with the memory device 604 in accordance with any other suitable communication protocol.

The memory device 604 of the data storage device 104 may include a non-volatile memory (e.g., NAND, BiCS family of memories, or other suitable memory). In some examples, the memory device 604 may be any type of flash memory. For example, the memory device 604 may be two-dimensional (2D) memory or three-dimensional (3D) flash memory. The memory device 604 may include one or more memory dies 603. Each of the one or more memory dies 603 may include one or more memory blocks 612 (e.g., one or more erase blocks). Each memory block 612 may include one or more groups of storage elements, such as a representative group of storage elements 607A-607N. The group of storage elements 607A-607N may be configured as a wordline. The group of storage elements 607A-607N may include multiple storage elements (e.g., memory cells that are referred to herein as a “string”), such as a representative storage elements 609A and 609N, respectively.

The memory device 604 may include support circuitry, such as read/write circuitry 640 to support operation of the one or more memory dies 603. Although depicted as a single component, the read/write circuitry 640 may be divided into separate components of the memory device 604, such as read circuitry and write circuitry. The read/write circuitry 640 may be external to the one or more memory dies 603 of the memory devices 604. Alternatively, one or more individual memory dies may include corresponding read/write circuitry that is operable to read from and/or write to storage elements within the individual memory die independent of any other read and/or write operations at any of the other memory dies.

The data storage device controller 606 is coupled to the memory device 604 (e.g., the one or more memory dies 603) with a bus 605, an interface (e.g., interface circuitry), another structure, or a combination thereof. For example, the bus 605 may include multiple distinct channels to enable the data storage device controller 606 to communicate with each of the one or more memory dies 603 in parallel with, and independently of, communication with the other memory dies 603.

The data storage device controller 606 is configured to receive data and instructions from the mobile device 102 and to send data to the mobile device 102. For example, the data storage device controller 606 may send data to the mobile device 102 using the port 108, and the data storage device controller 606 may receive data from the mobile device 102 with the port 108. The data storage device controller 606 is configured to send data and commands (e.g., the memory operation 636, which may be a cycle operation of a memory block of the memory device 604) to the memory device 604 and to receive data from the memory device 604. For example, the data storage device controller 606 is configured to send data and a program or write command to cause the memory device 604 to store data to a specified address of the memory device 604. The write command may specify a physical address of a portion of the memory device 604 (e.g., a physical address of a word line of the memory device 604) that is to store the data.

The data storage device controller 606 is configured to send a read command to the memory device 604 to access data from a specified address of the memory device 604. The read command may specify the physical address of a region of the memory device 604 (e.g., a physical address of a word line of the memory device 604). The data storage device controller 606 may also be configured to send data and commands to the memory device 604 associated with background scanning operations, garbage collection operations, and/or wear-leveling operations, or other suitable memory operations.

The data storage device controller 606 may include a data storage device processor 624, a data storage device memory 626, and other associated circuitry. The data storage device memory 626 may be configured to store data and/or instructions that may be executable by the data storage device processor 624.

The data storage device controller 606 may send the memory operation 636 (e.g., a read command) to the memory device 604 to cause the read/write circuitry 640 to sense data stored in a storage element. For example, the data storage device controller 606 may send the read command to the memory device 604 in response to receiving a request for read access from the mobile device 102. In response to receiving the read command, the memory device 604 may sense the storage element 107A (e.g., using the read/write circuitry 640) to generate one or more sets of bits representing the stored data.

Generally, one or more components of the data storage device 104, such as the memory devices 604 and/or the data storage device controller 606 are solid state integrated circuit packages. These packages are disposed on a printed circuit board (“PCB”) or other applicable substrates. Often a grid array component is used to maximize the connection points between the package and the substrate.

The power controller 510 may include a power controller electronic processor 650, a power controller memory 652, and other associated circuitry. The power controller memory 652 may be configured to store data and/or instructions that may be executable by the power controller electronic processor 650. The power controller 510 may be configured to manage the flow of power between the mobile device 102, the data storage device 104, and the external power supply 106, as described below in more detail. The power controller 510 may also control power to the memory 550 to power at least the data storage device controller 606.

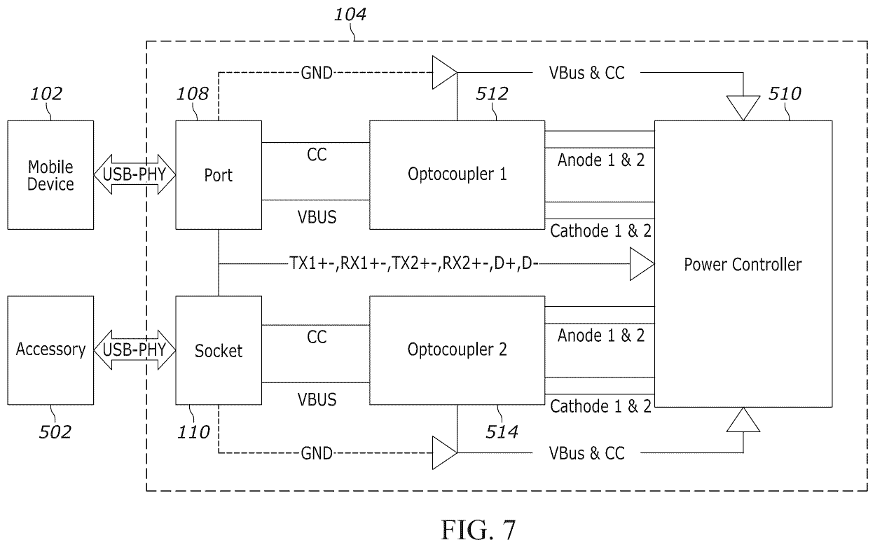

FIG. 7 is a block diagram illustrating wired interfaces between the data storage device 104 and the mobile device 102 and the accessory 502, respectively. The first optocoupler 512 is connected to the port 108 and the power controller 510. The second optocoupler 514 is connected to the socket 110 and the power controller 510. The first optocoupler 512 and the second optocoupler 514 are configured to disable the VBUS and Channel Configuration (CC) pins of the port 108 and the socket 110, respectively, based on control signals from the power controller 510.

The control signals may be a voltage applied by the power controller 510 to the anode and cathode pins of the first optocoupler 512 and/or the second optocoupler 514. The port 108 and the socket 110 may also be directly coupled to the power controller 510 for data transfer (for example, via the TX1+−, RX1+−, TX2+−, RX2+−, D+, and D− pins) between the mobile device 102 to the power controller 510 through the port 108 and data transfer between the accessory 502 and the power controller 510 through the socket 110. Accordingly, for data communication, the mobile device 102 and the accessory 502 may bypass the first optocoupler 512 and the second optocoupler 514. In some instances, during data transfer, data is provided from the mobile device 102 directly to the data storage device controller 606. In such an instance, data being transferred from the mobile device 102 to the data storage device 104 may bypass the power controller 510.

In some implementations, the first optocoupler 512 and the second optocoupler 514 are configured to disconnect power supplied to the power controller 510 via the mobile device 102 and the accessory 502 (e.g., via a charger), respectively, when the power controller 510 receives a power-enabled signal from the external power supply 106. For example, when the data storage device 104 is not connected to the external power supply 106, the data storage device 104 may instead receive power from the mobile device 102.

Upon detecting connection of the external power supply 106 to the data storage device 104, the first optocoupler 512 terminates power transfer between the mobile device 102 and the data storage device 104. As data communication bypasses the first optocoupler 512, data communication between the mobile device 102 and the data storage device 104 remains enabled. In another examples, when the data storage device 104 is not connected to the external power supply 106, the data storage device 104 may instead receive power from the accessory 502. Upon detecting connection of the external power supply 106 to the data storage device 104, the second optocoupler 514 terminates power transfer between the accessory 502 and the data storage device 104.

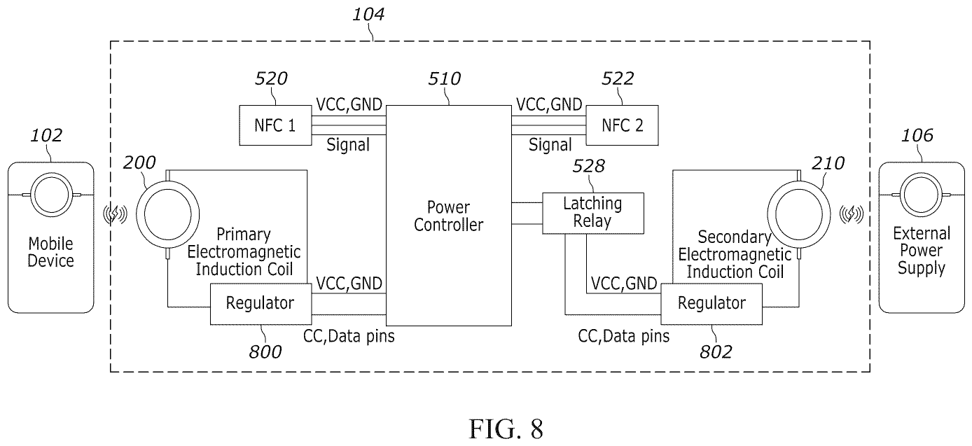

FIG. 8 is a block diagram illustrating wireless power interfaces and wireless communication interfaces between the data storage device 104 and the mobile device 102 and the external power supply 106, respectively. As previously noted, the data storage device 104 includes the first induction coil 200 and a regulator 800 for wireless power transfer between the data storage device 104 and the mobile device 102. The data storage device 104 also includes the second induction coil 210 and a regulator 802 for wireless power transfer between the external power supply 106 and the data storage device 104. The first regulator 800 regulates the flow of power between the first induction coil 200 and the power controller 510. The second regulator 802 regulates the flow of power between the second induction coil 210 and the power controller 510.

Additionally, the data storage device 104 includes the first communication circuit 520 and the second communication circuit 522. The first communication circuit 520 may be configured to detect a connection of the mobile device 102 to the data storage device 104. The second communication circuit 522 may be configured to detect a connection of the external power supply 106 to the data storage device 104. The power controller 510 may detect connection of the mobile device 102 and the external power supply 106 based on signals from the first communication circuit 520 and the second communication circuit 522, respectively.

The first induction coil 200 combined with the first communication circuit 520, as well as the second induction coil 210 combined with the second communication circuit 522, may form a MagSafe assembly. The first communication circuit 520 and the second communication circuit 522 may both be near field communication (NFC) circuits. In some instances, the first communication circuit 520 detects connection of the mobile device 102 to the data storage device 104 by sensing a current in the first induction coil 200. Similarly, in some instances, the second communication circuit 522 detects connection of the external power supply 106 to the data storage device 104 by sensing a current in the second induction coil 210.

The power controller 510 is connected to the voltage control (VCC), channel control (CC), ground (GND), and data pins of the first induction coil 200 and the second induction coil 210 such that the power controller power controller 510 may monitor and control the flow of power between the first induction coil 200, the power controller 510, and the second induction coil 210. The power controller 510 may also control the latching relay 528 to control whether the power controller 510 receives power from the second induction coil 210. For example, the power controller 510 receives a signal from the second communication circuit 522 indicating that the external power supply 106 is connected to the data storage device 104. The power controller 510 controls the latching relay 528 to permit the flow of power such that wireless power received by the second induction coil 210 is provided to the power controller 510. In some implementations, the power controller 510 may also provide a portion of the power received by the second induction coil 210 to the first induction coil 200, such that power is passed through the data storage device 104 to supply the mobile device 102.

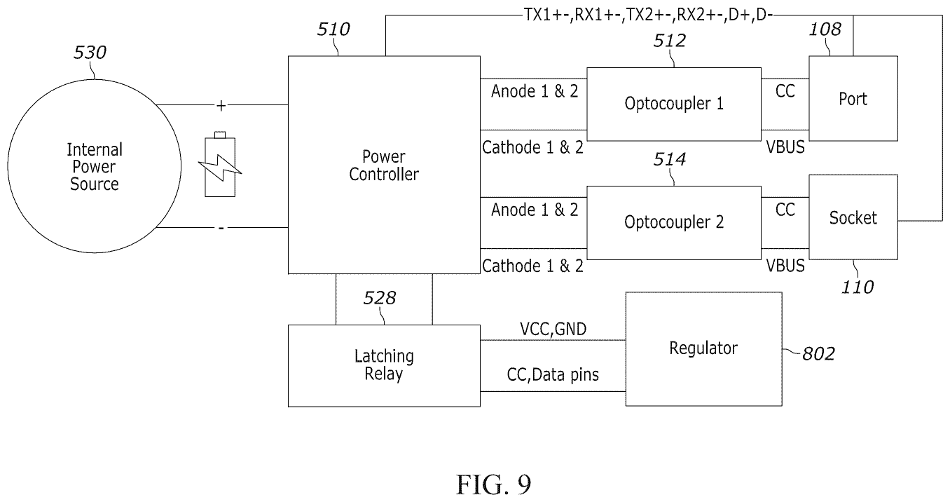

FIG. 9 is a block diagram of an intermediate internal power supply system of the data storage device 104. For example, an internal power source 530 may be provided to supply the power controller 510 with power when transitioning between receiving power from the mobile device 102 and receiving power from the external power supply 106. For example, the mobile device 102 may be coupled to the data storage device 104 via a wired connection such that power is transferred from the mobile device 102 to the data storage device 104. Upon connection of the external power supply 106 to the data storage device 104, the power controller 510 transitions from receiving power from the mobile device 102 to receiving power from the external power supply 106. During this period of time, the internal power source 530 is connected to the power controller 510 such that the power controller 510 is powered during the transition. During the transition, the first optocoupler 512 and/or the second optocoupler 514 are controlled by the power controller 510 to disconnect the port 108 and the socket 110 from providing power to the power controller 510. The latching relay 528 is controlled to selectively connect the power controller 510 to the second regulator 802 (and, therefore, the second induction coil 210). Once the power controller 510 is receiving power from the second induction coil 210, the internal power source 530 is disconnected from the power controller 510.

In some instances, the internal power source 530 is a capacitor (e.g., a super capacitor). In other instances, the internal power source 530 includes one or more battery cells. In such an instance, the internal power source 530 may be a rechargeable power source. Additionally, in some instances, the power controller 510 may control the internal power source 530 to supply power to a connected device, such as the mobile device 102 and/or the accessory 502. In such an instance, the mobile device 102 and/or the accessory 502 are charged by the internal power source 530.

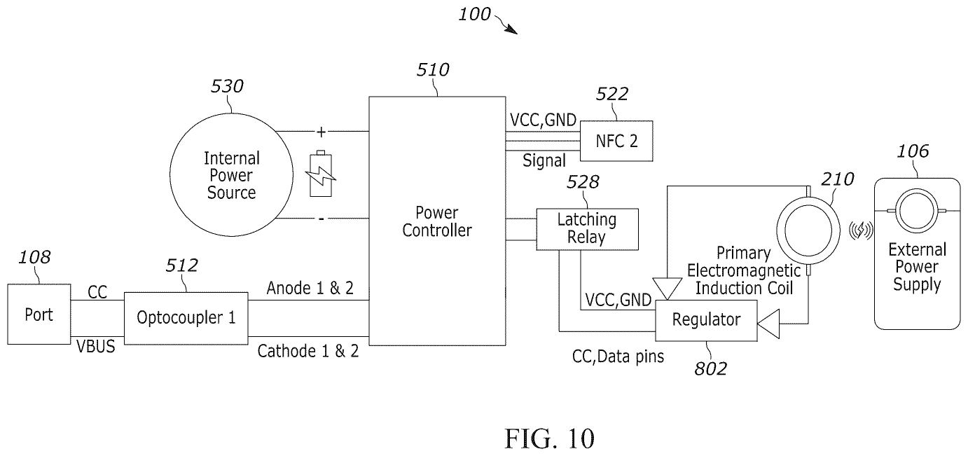

FIGS. 10-14 provide block diagrams of various power distribution schemes 1000-1400 performed by the data storage device 104. FIG. 10, for example, is a block diagram illustrating a power distribution scheme 1000 in which the power controller 510 of the data storage device 104 is communicating with and regulating power from the external power supply 106 external power supply 106. Prior to connection of the external power supply 106, the power controller 510 receives power from the port 108. The second communication circuit 522 detects connection of the external power supply 106 to the data storage device 104 and transmits a signal to the power controller 510 indicative of the connection. Upon receiving the signal from the second communication circuit 522, the power controller 510 controls the internal power source 530 to provide power to the power controller 510 and controls the first optocoupler 512 to disconnect power lines of the port 108 from the power controller 510. The power controller 510 then controls the latching relay 528 to allow current to flow from the second induction coil 210, through the second regulator 802, to the power controller 510.

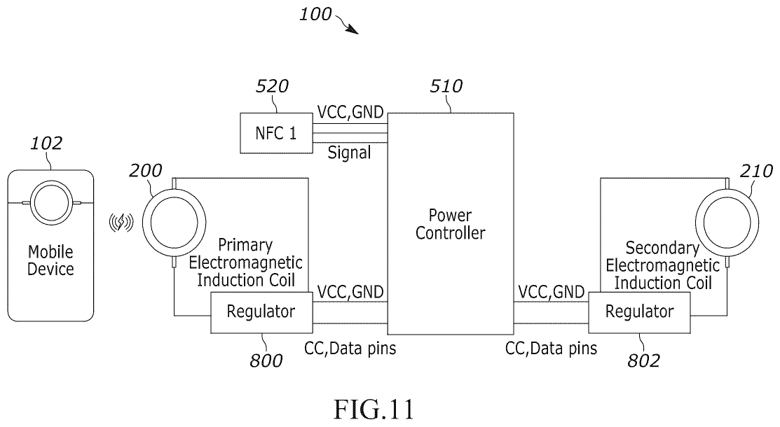

Once the connection between the data storage device 104 and the external power supply 106 is established, the data storage device 104 may redirect a portion of the power to the mobile device 102. For example, FIG. 11 is a block diagram illustrating a power distribution scheme 1100 in which the power controller 510 of the data storage device 104 is communicating with and regulating power to the mobile device 102. The power controller 510 receives power from the second induction coil 210 through the second regulator 802. The first communication circuit 520 detects connection of the mobile device 102 to the data storage device 104. The power controller 510 redirects a portion of the power from the second induction coil 210 to the power system 100 through the first regulator 800 such that the portion of the power is passed through the data storage device 104 from the external power supply 106 to the mobile device 102 to charge the mobile device 102.

In some instances, the power controller 510 determines that the mobile device 102 is connected to the power controller 510 for wireless power transfer but not for data transfer. In such an instance, the power controller 510 may control the power from the second induction coil 210 such that power is provided to the first induction coil 200 without providing power to the memory 550. Should the mobile device 102 connect to the data storage device 104 for data transfer (e.g., via the port 108), the power controller 510 then provides a portion of the power to the memory 550.

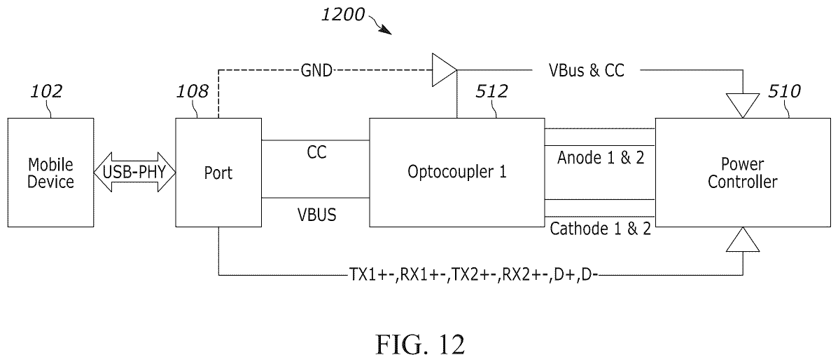

FIG. 12 is a block diagram illustrating a power distribution scheme 1200 in which the data storage device 104 is only connected to the mobile device 102. In the example of FIG. 12, power is supplied to the data storage device 104 from the mobile device 102 via the port 108. Data transfer may also occur between the data storage device 104 and the mobile device 102 via the port 108.

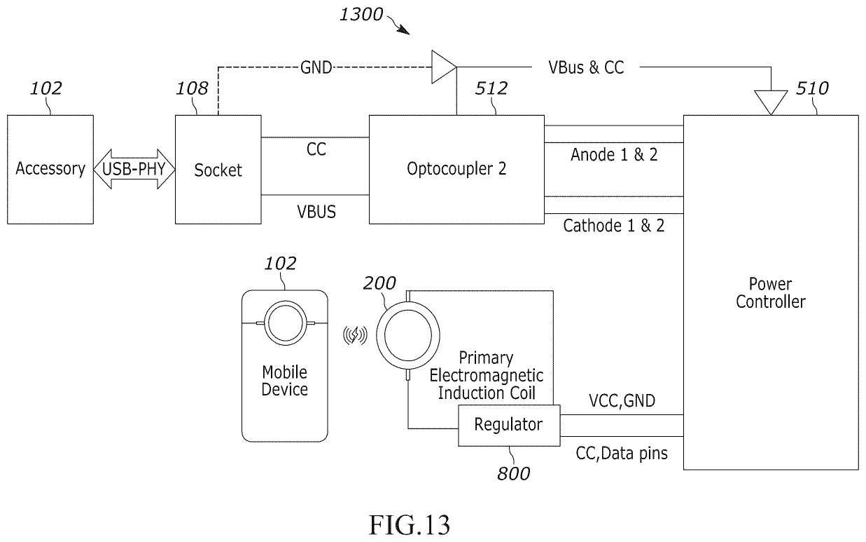

FIG. 13 is a block diagram illustrating a power distribution scheme 1300 in which the data storage device 104 is connected to the mobile device 102 via a wireless power interface and the data storage device 104 is connected to the accessory 502 via a wired interface. The power controller 510 receives power from the accessory 502 via the socket 110. The power controller 510 supplies a portion of the power from the accessory 502 to the mobile device 102 to charge the mobile device 102 via the first induction coil 200.

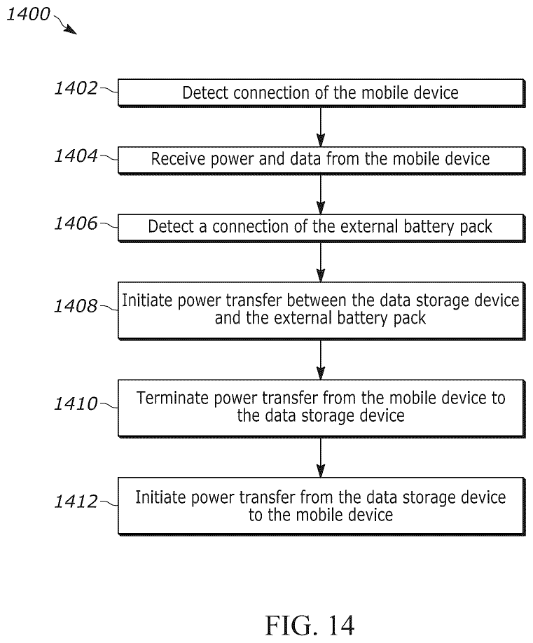

FIG. 14 is a block diagram illustrating a method 1400 of changing from power reception to power delivery performed by the power controller 510. At block 1402, the method 1400 includes the power controller 510 detecting connection of the mobile device 102 to the data storage device 104. For example, the first communication circuit 520 transmits a signal to the power controller 510 indicating connection of the mobile device 102 to the data storage device 104.

At block 1404, the method 1400 includes the power controller 510 receiving power from the mobile device 102. For example, the mobile device 102 connects to the data storage device 104 via a wired connection (e.g., via the port 108). The mobile device 102 provides power to the data storage device 104 via the wired connection.

At block 1406, the method 1400 includes the power controller 510 detecting a connection of the external power supply 106 to the data storage device 104. For example, the second communication circuit 522 transmits a signal to the power controller 510 indicating connection of the external power supply 106 to the data storage device 104.

At block 1408, the method 1400 includes the power controller 510 initiating power transfer between the data storage device 104 and the external power supply 106. For example, the power controller 510 controls the second induction coil 210 to receive wireless power from the external power supply 106.

At block 1410, the method 1400 includes the power controller 510 terminating power transfer from the mobile device 102 to the data storage device 104. For example, the power controller 510 controls the first optocoupler 512 to stop power transfer from the port 108 to the power controller 510 while still allowing the transfer of data from the port 108 to the power controller 510.

At block 1412, the method 1400 includes the power controller 510 initiating power transfer from the data storage device 104 to the mobile device 102. For example, the power controller 510 controls the first induction coil 200 to transfer a portion of the power received from the second induction coil 210 to the mobile device 102.

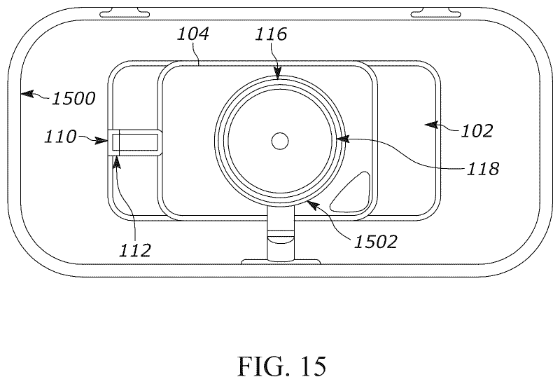

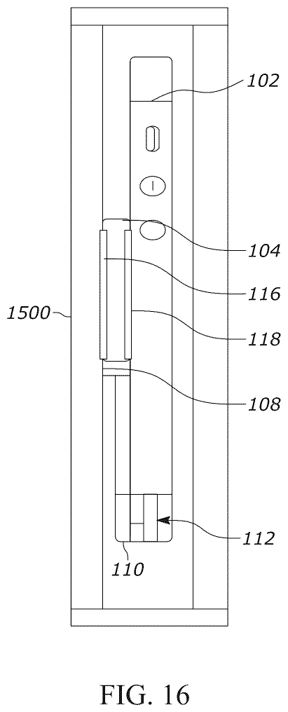

In some instances, the data storage device 104 is compatible with MagSafe film cages. FIG. 15 is a diagram of an example film cage 1500 configured to support a mobile device 102 connected to a data storage device 104. FIG. 16 illustrates a side view of the example film cage 1500. The mobile device 102 is connected to the data storage device 104 via the second power transfer circuit 118, as previously described. The film cage 1500 includes a magnet 1502 configured to magnetically couple with the data storage device 104 (for example, via the first magnetic array 202), thereby holding the data storage device 104 and the mobile device 102 in place.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain implementations and should in no way be construed to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A data storage device comprising:
a controller configured to:
wirelessly receive, with a first power transfer circuit, power from an external power supply; and
wirelessly supply, with a second power transfer circuit, a portion of the power from the external power supply to a mobile device.

2. The data storage device of claim 1, wherein the first power transfer circuit and the second power transfer circuit are MagSafe assemblies.

3. The data storage device of claim 1, wherein the first power transfer circuit includes a first induction coil, and wherein the second power transfer circuit includes a second induction coil.

4. The data storage device of claim 1, further comprising a first port configured to electrically couple to a corresponding port of the mobile device, wherein connection of the mobile device to the first port establishes data communication between the mobile device and the data storage device.

5. The data storage device of claim 4, further comprising an optocoupler connected to the first port, wherein the controller is further configured to:
receive power from the mobile device via the first port;
detect connection of the external power supply to the data storage device; and
control, in response to the detection of the connection of the external power supply to the data storage device, the optocoupler to terminate a flow of power from the first port to the controller.

6. The data storage device of claim 1, further comprising:
a first wireless communication circuit configured to detect a first coupling of the data storage device to the external power supply; and
a second wireless communication circuit configured to detect a second coupling of the data storage device to the mobile device.

7. The data storage device of claim 1, further comprising:
an internal power supply configured to supply power to the controller.

8. The data storage device of claim 1, further comprising:
a latching relay configured to selectively permit a transfer of power from the second power transfer circuit to the controller.

9. A method performed by a data storage device, the method comprising:
receiving, with a power controller, power from a mobile device;
detecting, with the power controller, a connection of an external power supply to the data storage device;
initiating, with the power controller and in response to the detection of the connection of the external power supply to the data storage device, wireless power transfer from the external power supply to the data storage device; and
terminating, with the power controller and in response to the detection of the connection of the external power supply to the data storage device, power transfer from the mobile device to the data storage device.

10. The method of claim 9, wherein receiving, with the power controller, power from the mobile device includes receiving, with the power controller, power from the mobile device through a wired connection.

11. The method of claim 9, further comprising:
receiving, with a data storage device controller, data from the mobile device.

12. The method of claim 9, wherein terminating, with the power controller and in response to the detection of the connection of the external power supply to the data storage device, power transfer from the mobile device to the data storage device includes controlling an optocoupler to terminate a flow of current along a power line between the mobile device and the data storage device.

13. The method of claim 9, further comprising supply, with the power controller, a portion of the wireless power from the external power supply to a memory.

14. The method of claim 9, wherein initiating, with the power controller and in response to the detection of the connection of the external power supply to the data storage device, wireless power transfer from the external power supply to the data storage device includes controlling a latch relay to permit power transfer from a power transfer circuit to the power controller.

15. The method of claim 9, further comprising:
detecting, with the power controller, a connection of the mobile device to the data storage device.

16. A data storage device comprising:
a controller configured to:
receive power from a mobile device;
detect a connection of an external power supply to the data storage device;
initiate, in response to the detection of the connection of the external power supply to the data storage device, wireless power transfer from the external power supply to the data storage device; and
terminate, in response to the detection of the connection of the external power supply to the data storage device, power transfer from the mobile device to the data storage device.

17. The data storage device of claim 16, wherein the controller is configured to:
receive data from a port; and
provide the data to a memory.

18. The data storage device of claim 16, wherein, to terminate power transfer from the mobile device to the data storage device, the controller is configured to control an optocoupler to terminate a flow of current along a power line between the mobile device and the data storage device.

19. The data storage device of claim 16, wherein the controller is further configured to:
supply a portion of the wireless power from the external power supply to a memory.

20. The data storage device of claim 16, wherein the controller is further configured to:
pass-through a portion of the wireless power from the external power supply to a power transfer circuit associated with the mobile device.
